(19) United States
(12) Patent Application Publication
(10) Pub. No.: US 2010/0203391 A1
(43) Pub. Date: Aug. 12, 2010

(54) MESOPOROUS CARBON MATERIAL FOR ENERGY STORAGE

(75) Inventors: Sergey D. Lopatin, Santa Clara, CA (US); Robert Z. Bachrach, Burlingame, CA (US); Dmitri A. Brevnov, Santa Clara, CA (US); Christopher Lazik, Fremont, CA (US); Miao Jin, San Jose, CA (US); Yuri S. Uritsky, Newark, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/696,445

(22) Filed: Jan. 29, 2010

Related U.S. Application Data
(63) Continuation-in-part of application No. 12/459,313, filed on Jun. 30, 2009.
(60) Provisional application No. 61/151,159, filed on Feb. 9, 2009.
(60) Provisional application No. 61/156,862, filed on Mar. 2, 2009.
(60) Provisional application No. 61/155,454, filed on Feb. 25, 2009.

(51) Int. Cl. H01M 4/583; D01F 9/12; H01M 4/04; B05D 5/12; H01G 9/058; H01G 9/042; H01G 9/048

(52) U.S. Cl. 429/231.8; 423/447.2; 427/58; 427/79; 361/516; 361/508; 977/734; 977/742; 977/773; 977/843; 977/752

(57) ABSTRACT

A mesoporous carbon material formed on an electrode surface in an energy storage device, and a method of forming the same are disclosed. The mesoporous carbon material acts as a high surface area ion intercalation medium for the energy storage device, and is made up of CVD-deposited carbon fullerene “onions” and carbon nanotubes (CNTs) that are interconnected in a fullerene/CNT hybrid matrix. The fullerene/CNT hybrid matrix is a high porosity material that is capable of retaining lithium ions in concentrations useful for storing significant quantities of electrical energy. The method, according to one embodiment, includes vaporizing a high molecular weight hydrocarbon precursor and directing the vapor onto a conductive substrate to form a mesoporous carbon material thereon.

### CROSS-REFERENCE TO RELATED APPLICATIONS

This application claims benefit of U.S. Provisional Patent Application Ser. No. 61/151,159 (APPM/13530L), filed Feb. 9, 2009, and is a continuation-in-part of co-pending U.S. patent application Ser. No. 12/459,313 (APPM/013529), filed Jun. 30, 2009, which claims the benefit of U.S. Provisional Patent Application Ser. No. 61/156,862 (APPM/013529L02), filed Mar. 2, 2009 and U.S. Provisional Patent Application Ser. No. 61/155,454 (APPM/013529L), filed Feb. 25, 2009, all of which are herein incorporated by reference.

### BACKGROUND OF THE INVENTION

1. Field of the Invention

Embodiments of the present invention relate generally to electrical energy storage devices, and more specifically, to a mesoporous carbon material for use in such devices and methods of forming same.

2. Description of the Related Art

Fast-charging, high-capacity energy storage devices, such as supercapacitors and lithium—(Li) ion batteries, are used in a growing number of applications, including portable electronics, medical, transportation, grid-connected large energy storage, renewable energy storage, and uninterruptible power supply (UPS). In modern rechargeable energy storage devices, the current collector is made of an electric conductor. Examples of materials for the positive current collector (the cathode) include aluminum, stainless steel, and nickel. Examples of materials for the negative current collector (the anode) include copper, stainless steel, and nickel. Such collectors can be in the form of a foil, a film or a thin plate, having a thickness that generally ranges from about 6 to 50 micrometers.

The active electrode material in the positive electrode of a Li-ion battery is typically selected from lithium transition metal oxides, such as LiMn₂O₄, LiCoO₂ and/or LiNiO₂, and includes electroconductive particles, such as carbon or graphite, and binder material. Such positive electrode material is considered to be a lithium-intercalation compound, in which the quantity of conductive material is in the range from 0.1% to 15% by weight.

Graphite is usually used as the active electrode material of the negative electrode and can be in the form of a lithium-intercalation meso carbon micro beads (MCMB) powder made up of MCMBs having a diameter of approximately 10 micrometers. The lithium-intercalation MCMB powder is dispersed in a polymeric binder matrix. The polymers for the binder matrix are made of thermoplastic polymers including polymers with rubber elasticity. The polymeric binder serves to bind together the MCMB material powders to preclude crack formation and prevent disintegration of the MCMB powder on the surface of the current collector. The quantity of polymeric binder is in the range of 2% to 30% by weight.

The separator of Li-ion batteries is typically made from microporous polyethylene and polyolefine, and is applied in a separate manufacturing step.

For most energy storage applications, the charge time and capacity of energy storage devices are important parameters. In addition, the size, weight, and/or expense of such energy storage devices can be significant limitations. The use of electroconductive particles and MCMB powders and their associated binder materials in energy storage devices has a number of drawbacks. Namely, such materials limit the minimum thickness of the electrodes constructed from such materials, produce unfavorable internal resistance in an energy storage device, and require complex and eclectic manufacturing methods.

Accordingly, there is a need in the art for faster charging, higher capacity energy storage devices that are smaller, lighter, and can be more cost effectively manufactured.

### SUMMARY OF THE INVENTION

According to one embodiment of the invention, a method of forming an intercalation layer on an electrode comprises vaporizing a high molecular weight hydrocarbon precursor and directing the vaporized high molecular weight hydrocarbon precursor onto a conductive substrate to deposit a mesoporous carbon material comprising carbon fullerene onions and carbon nano-tubes thereon, wherein the high molecular weight hydrocarbon precursor comprises molecules having at least 18 carbon (C) atoms and wherein a diameter of the spherical carbon fullerene onions and a length of the carbon nanotubes are between about 5 nm and about 50 nm.

According to another embodiment of the invention, an electrode for an energy storage device comprises a conductive substrate and a mesoporous carbon material comprising carbon fullerene onions and carbon nano-tubes formed on a surface of the conductive substrate, wherein a diameter of the spherical carbon fullerene onions and a length of the carbon nanotubes are between about 5 nm and about 50 nm.

According to another embodiment of the invention, a mesoporous intercalation layer comprises a first carbon fullerene onion having a first diameter of between about 5 nm and about 50 nm, a first carbon nano-tube connected to the first carbon fullerene onion and having a first length of between about 5 nm and about 50 nm, a second carbon fullerene onion connected to the first carbon nano-tube and having a second diameter of between about 5 nm and about 50 nm, a second carbon nano-tube connected to the first carbon nano-tube and having a second length of between about 5 nm and about 50 nm, and a third carbon fullerene onion connected to the second carbon nano-tube and having a third diameter of between about 5 nm and about 50 nm.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B illustrate schematic cross-sectional views of an electrode with a mesoporous carbon material formed thereon, according to one embodiment of the invention;

FIG. 2 illustrates a conceptual model of a carbon fullerene, which may make up one of the multiple layers of spherical carbon fullerene onions in a mesoporous carbon material;

FIGS. 3A-3B illustrate conceptual models of configurations of spherical carbon fullerene onions;

FIG. 4 illustrates a conceptual model of one configuration of carbon nanotube that may be incorporated into embodiments of the invention;

FIGS. 5A-E illustrate a variety of possible configurations of carbon fullerene onions and carbon nanotubes that may form the three-dimensional structures making up a mesoporous carbon material, according to embodiments of the invention;

FIGS. 6A-E are schematic illustrations of different configurations of hybrid fullerene chains that may make up a fullerene-hybrid material, according to embodiments of the invention;

FIG. 7A is an SEM image of fullerene-hybrid material showing carbon fullerene onions formed into high-aspect ratio hybrid fullerene chains, according to embodiments of the invention;

FIG. 7B is a TEM image of a multi-walled shell connected by a carbon nanotube to another fullerene onion, according to an embodiment of the invention;

FIG. 8A is a schematic illustration of a Li-ion battery with an intercalation layer formed from a mesoporous carbon material, according to an embodiment of the invention;

FIG. 8B is a schematic diagram of a single sided Li-ion battery cell bi-layer electrically connected to a load according to component embodiments described herein;

FIG. 9A illustrates a schematic cross-sectional view of a conductive electrode with a surface enhanced with a plurality of high surface area microstructures, according to an embodiment of the invention;

FIG. 9B illustrates an electrode with a mesoporous carbon material formed as a thin layer deposited conformally on high surface area microstructures, according to an embodiment of the invention;

FIG. 9C illustrates an electrode with a mesoporous carbon material formed thereon as a planarizing layer, according to an embodiment of the invention;

FIG. 10 is a process flow chart summarizing a method for forming a mesoporous carbon material on an electrode, according to one embodiment of the invention; and

FIG. 11 is a schematic side view of one embodiment of a chemical vapor deposition (CVD) processing chamber for performing embodiments described herein.

### DETAILED DESCRIPTION

Embodiments of the invention contemplate a mesoporous carbon material that is formed on an electrode surface in an energy storage device, and a method of forming the same. A mesoporous material, as defined herein, is a material containing pores with diameters between about 2 nanometers (nm) and about 50 nm. The mesoporous carbon material acts as a high surface area ion intercalation medium for the energy storage device, and is made up of CVD-deposited carbon fullerene “onions” and carbon nanotubes (CNTs) that are interconnected in a fullerene/CNT hybrid matrix. The fullerene onions and CNTs are formed on a conductive surface of the electrode by a continuous self-assembly process, in which the fullerene onions and CNTs are interconnected in high aspect ratio chains or dendrites that interweave to form the hybrid matrix. The fullerene/CNT hybrid matrix is a high porosity material that is capable of retaining lithium ions in concentrations useful for storing significant quantities of electrical energy. The method, according to one embodiment, includes vaporizing a high molecular weight hydrocarbon precursor and directing the vapor onto a conductive substrate to form a mesoporous carbon material thereon.

While the particular apparatus in which the embodiments described herein can be practiced is not limited, it is particularly beneficial to practice the embodiments on a web-based roll-to-roll system sold by Applied Materials, Inc., Santa Clara, Calif. Exemplary roll-to-roll and discrete substrate systems on which the embodiments described herein may be practiced are described herein and in further detail in U.S. Provisional Patent Application Ser. No. 61/243,813, (Attorney Docket No. APPM/014044/ATG/ATG/ESONG), titled APPARATUS AND METHODS FOR FORMING ENERGY STORAGE OR PV DEVICES IN A LINEAR SYSTEM and U.S. patent application Ser. No. 12/620,788, (Attorney Docket No. APPM/012922/EES/AEP/ESONG), titled APPARATUS AND METHOD FOR FORMING 3D NANOSTRUCTURE ELECTRODE FOR ELECTROCHEMICAL BATTERY AND CAPACITOR, all of which are herein incorporated by reference in their entirety.

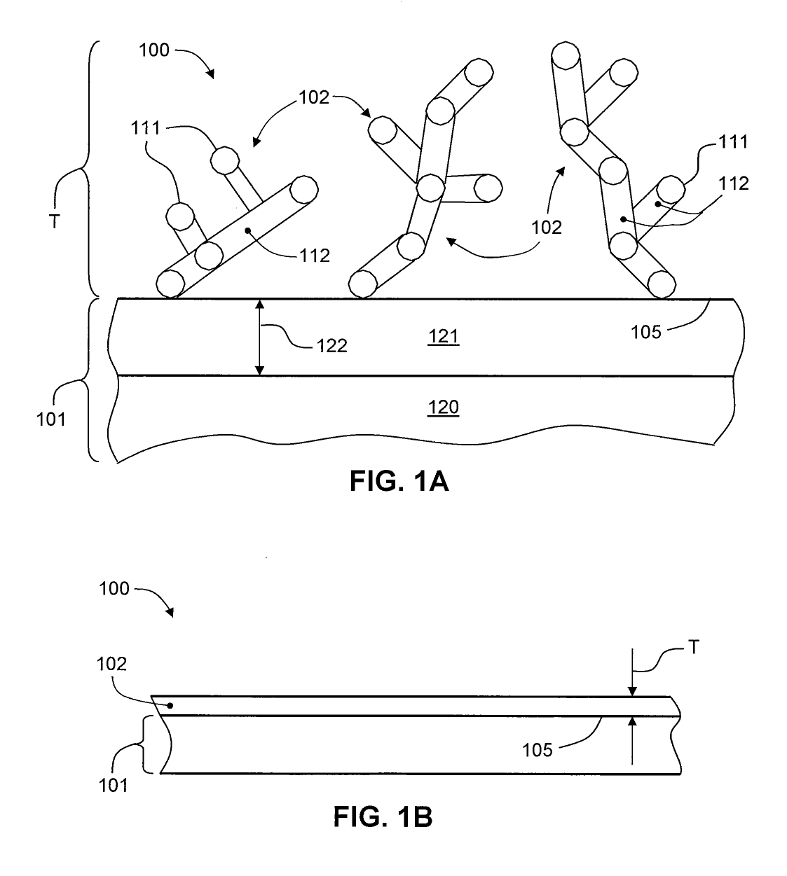

FIGS. 1A and 1B illustrate schematic cross-sectional views of an electrode 100 with a mesoporous carbon material 102 formed thereon, according to one embodiment of the invention. FIG. 1A depicts mesoporous carbon material 102 at an initial stage of formation, and FIG. 1B depicts mesoporous carbon material 102 after being fully formed on electrode 100. Electrode 100 includes a conductive substrate 101 and may be a component of a number of energy storing devices, including an anode in a Li-ion battery, a supercapacitor electrode, or a fuel cell electrode. Mesoporous carbon material 102 is comprised of spherical carbon fullerene “onions” 111 and carbon nanotubes 112, and is formed on a surface 105 of conductive substrate 101 by a nano-scale self-assembly process, described below.

Conductive substrate 101 may be a metallic plate, a metallic foil, or a non-conductive substrate 120 with a conductive layer 121 formed thereon, as shown in FIG. 1. Metallic plates or foils contemplated by embodiments of the invention may include any metallic, electrically conductive material useful as an electrode and/or conductor in an energy storage device. Such conductive materials include copper (Cu), aluminum (Al), nickel (Ni), stainless steel, palladium (Pd), and platinum (Pt), among others. For example, palladium and platinum are particularly useful for electrode structures used in fuel cells, whereas copper, aluminum (Al), ruthenium (Ru), and nickel (Ni) may be better suited for use in batteries and/or supercapacitors. Non-conductive substrate 120 may be a glass, silicon, or polymeric substrate and/or a flexible material, and conductive layer 121 may be formed using conventional thin film deposition techniques known in the art, including physical vapor deposition (PVD), chemical vapor deposition (CVD), atomic layer deposition (ALD), thermal evaporation, and electrochemical plating, among others. Conductive layer 121 may include any metallic, electrically conductive material useful as an electrode in an energy storage device, as listed above for conductive substrate 101. The thickness 122 of conductive layer 121 depends on the electrical requirements of electrode 100.

Mesoporous carbon material 102 is made up of spherical carbon fullerene onions 111 connected by carbon nanotubes 112, as illustrated in FIG. 1. Carbon fullerenes are a family of carbon molecules that are composed entirely of carbon atoms and are in the form of a hollow sphere, ellipsoid, tube, or plane. The carbon fullerene onion is a variation of spherical fullerene carbon molecule known in the art and is made up of multiple nested carbon layers, where each carbon layer is a spherical carbon fullerene, or “buckyball,” of increasing diameter. Carbon nanotubes, also referred to as “buckytubes,” are cylindrical fullerenes, and are usually only a few nanometers in diameter and of various lengths. Carbon nanotubes are also known in the art when formed as separate structures and are not connected to fullerene onions. The unique molecular structure of carbon nanotubes results in extraordinary macroscopic properties, including high tensile strength, high electrical conductivity, high ductility, high resistance to heat, and relative chemical inactivity, many of which are useful for components of energy storage devices.

FIG. 2 illustrates a conceptual model of a carbon fullerene 200, which may make up one of the multiple layers of the spherical carbon fullerene onions 111 in fullerene-hybrid material 102. Spherical carbon fullerene 200 is a C₆₀ molecule and consists of 60 carbon atoms 201 configured in twenty hexagons and twelve pentagons as shown. A carbon atom 201 is located at each vertex of each polygon and a bond is formed along each polygon edge 202. In scientific literature it is reported that the van der Waals diameter of spherical carbon fullerene 200 is about 1 nanometer (nm), and the nucleus-to-nucleus diameter of spherical carbon fullerene 200 is about 0.7 nm.

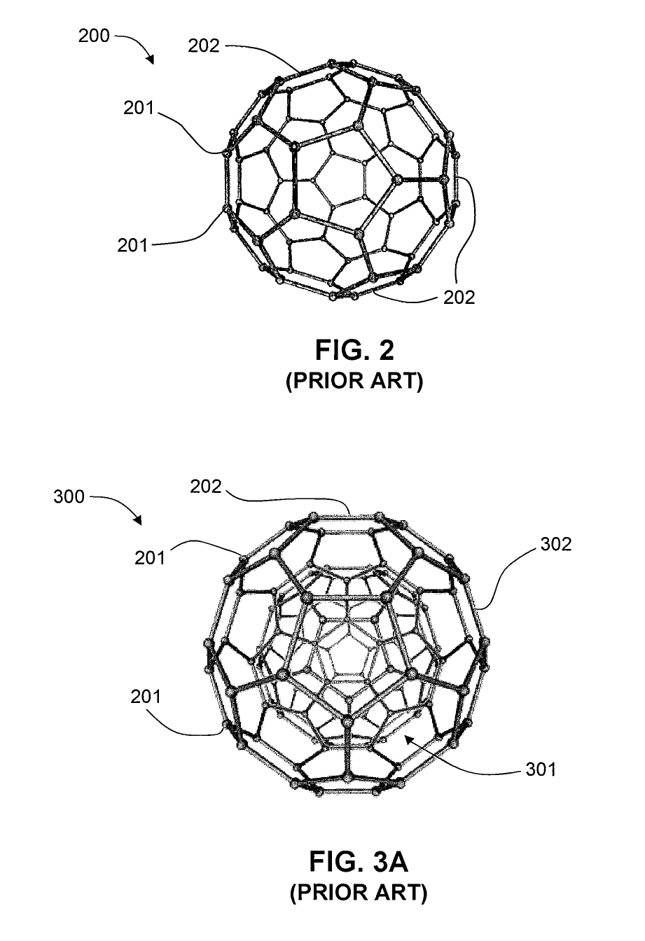

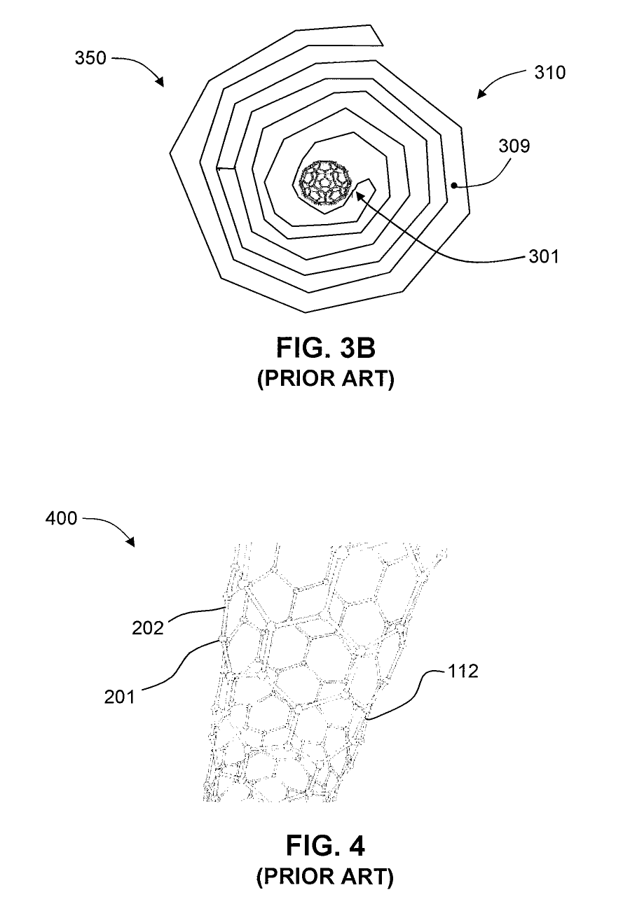

FIG. 3A illustrates a conceptual model 300 of one configuration of a spherical carbon fullerene onion 111, as reported in the literature. In this example, spherical carbon fullerene onion 111 includes a C₆₀ molecule 301 similar to spherical carbon fullerene 200 and one or more larger carbon fullerene molecules 302 surrounding C₆₀ molecule 301, forming a carbon molecule having a multi-wall shell, as shown. Modeling well known in the art indicates that C₆₀ is the smallest spherical carbon fullerene present in Fullerene onion structures, such as spherical carbon fullerene onion 111. Larger carbon fullerene molecule 302 is a spherical carbon fullerene molecule having a larger carbon number than C₆₀ molecule 301, e.g., C₇₀, C₈₄, O₁₁₂, etc. In one embodiment, C₆₀ molecule 301 may be contained in multiple larger carbon fullerene onion layers, e.g., C₇₀, C₈₄, C₁₁₂, etc., thereby forming a fullerene onion having more than two layers.

FIG. 3B illustrates a conceptual model 350 of another configuration of a spherical carbon fullerene onion 111, as reported in the literature. In this embodiment, spherical carbon fullerene onion 111 includes C₆₀ molecule 301 and multiple layers of graphene planes 309 surrounding C₆₀ molecule 301 and forming a carbon molecule having a multi-wall shell 310, as shown. Alternatively, a spherical carbon fullerene having a larger carbon number than 60 may form the core of spherical carbon fullerene onion 111, e.g., C₇₀, C₈₄, O₁₁₂, etc. In another embodiment, a nano-particle comprised of metal, e.g., nickel (Ni), cobalt (Co), palladium (Pd), and iron (Fe), metal oxide, or diamond may instead form the core of spherical carbon fullerene onion 111.

As described above in conjunction with FIG. 1, carbon fullerene onions 111 of mesoporous carbon material 102 are connected to each other by carbon nanotubes 112, thereby forming extended three-dimensional structures on surface 105 of conductive substrate 101, according to embodiments of the invention. FIG. 4 illustrates a conceptual model 400 of one configuration of carbon nanotube 112 that may be incorporated into embodiments of the invention. Conceptual model 400 shows the three-dimensional structure of carbon nanotube 112. As with spherical carbon fullerene onion 111, carbon atoms 201 reside at each vertex of the polygons that make up carbon nanotube 112, and a bond is formed along each polygon edge 202. The diameter 401 of carbon nanotube 112 may be between about 1-10 nm. A single-wall CNT is illustrated in conceptual model 400, however, embodiments of the invention also contemplate that carbon nanotube 112 may include multi-wall CNTs or a combination of single-wall and multi-wall CNTs.

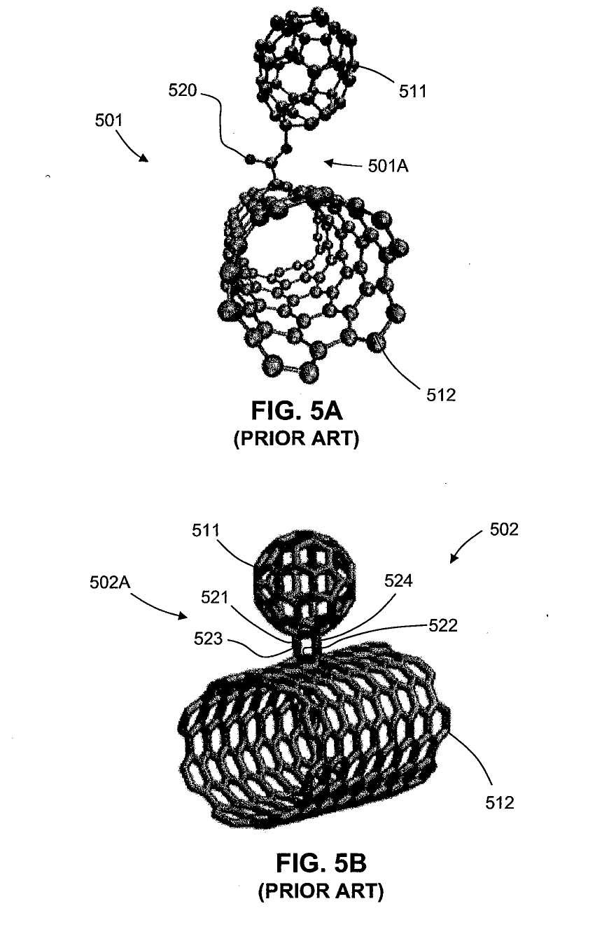

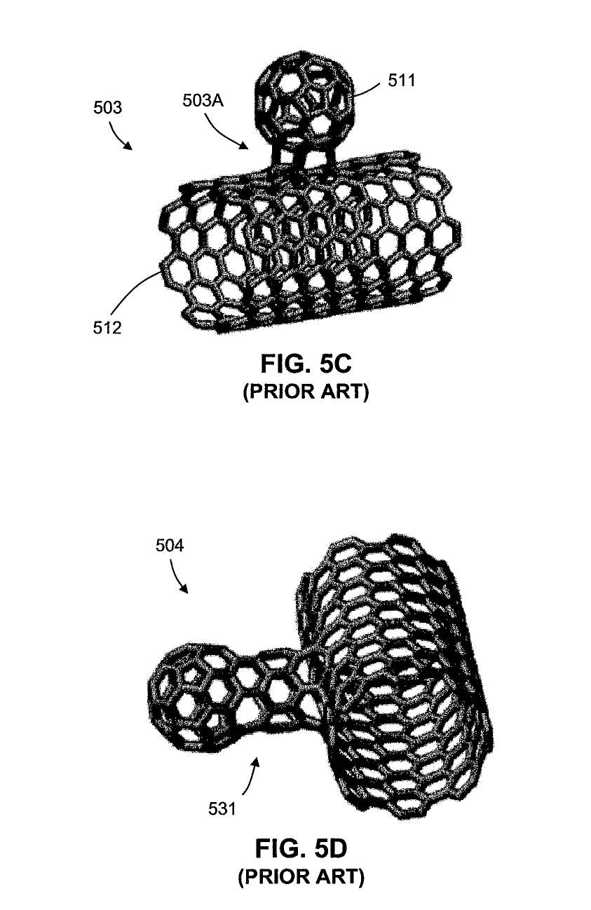

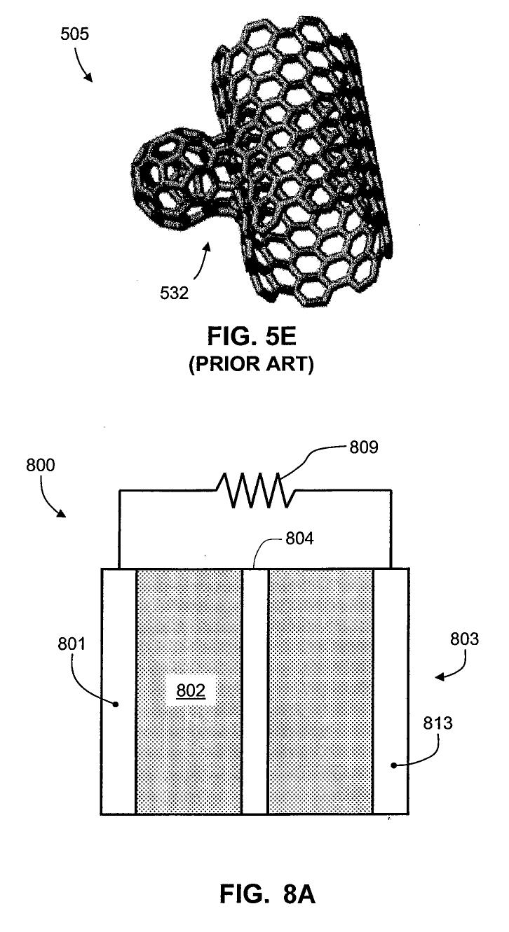

FIGS. 5A-E from theoretical reports in scientific literature illustrate a variety of possible configurations 501-505 of carbon fullerene onions 111 and carbon nanotubes 112 that may form the three-dimensional structures making up mesoporous carbon material 102, according to embodiments of the invention. Configurations 501-505 are consistent with images of mesoporous carbon material 102 obtained by the inventors using a SEM. As shown in FIGS. 5A-C, respectively, configurations 501, 502, and 503 depict the connection between a spherical carbon fullerene 511 and a carbon nanotube 512 as one or more single bonds. In configuration 501, connection 501A consists of a single carbon bond 520 or chain of single carbon bonds formed between a single vertex, i.e., a carbon atom, of spherical carbon fullerene 511 and a single vertex of carbon nanotube 512. In configuration 502, spherical carbon fullerene 511 is oriented so that a carbon bond 521 contained therein is oriented substantially parallel and proximate to a corresponding carbon bond 522 of carbon nanotube 512, as shown. In such a configuration, connection 502A consists of two carbon bonds 523, 524, which are formed as shown between the two vertices of carbon bond 521 and carbon bond 522. In configuration 503, spherical carbon fullerene 511 is oriented so that a polygon face is oriented substantially parallel and proximate to a corresponding polygon face of carbon nanotube 512. The vertices of the corresponding polygon faces are aligned, and the connection 503A consists of three to six carbon bonds formed between vertices of the two parallel polygon faces of spherical carbon fullerene 511 and carbon nanotube 512, as shown. Configurations 504 and 505, illustrated in FIGS. 5D and 5E, respectively, depict the connection between a spherical carbon fullerene 511 and carbon nanotube 512 as nanotube-like structures 531, 532, respectively.

For clarity, spherical carbon fullerene 511 in configurations 501-505 is illustrated as a single-walled spherical carbon fullerene. One of skill in the art will appreciate that configurations 501-505 are also equally applicable to multi-walled fullerene structures, i.e., carbon fullerene onions that may be contained in mesoporous carbon material 102. Similarly, carbon nanotube 512 is illustrated as a single wall CNT in configurations 501-505; however multi-wall CNTs may also be included in configurations 501-505. In one embodiment, the connection between spherical carbon fullerenes 511 and carbon nanotubes 512 in mesoporous carbon material 102 may include a combination of two or more of configurations 501-505.

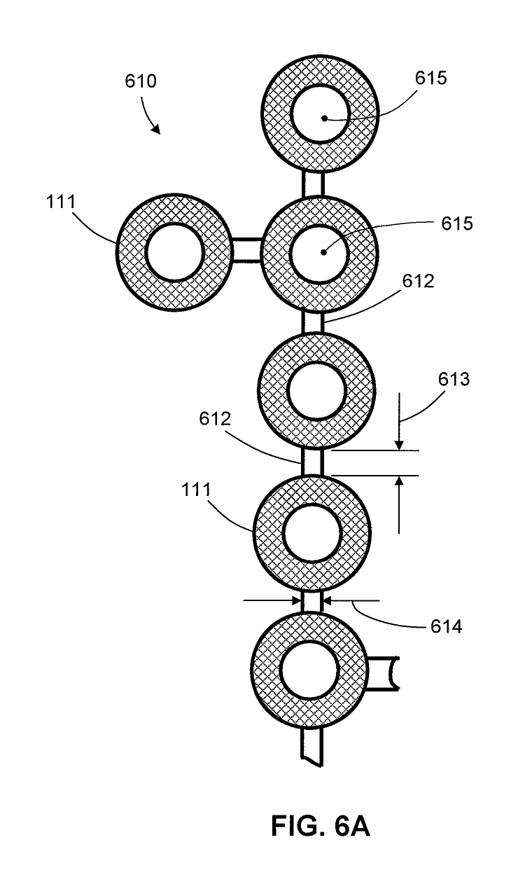

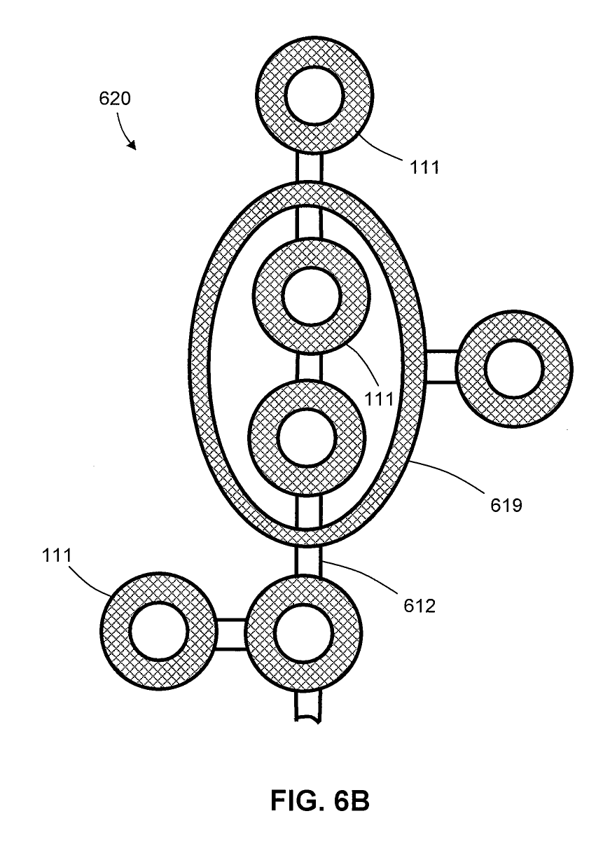

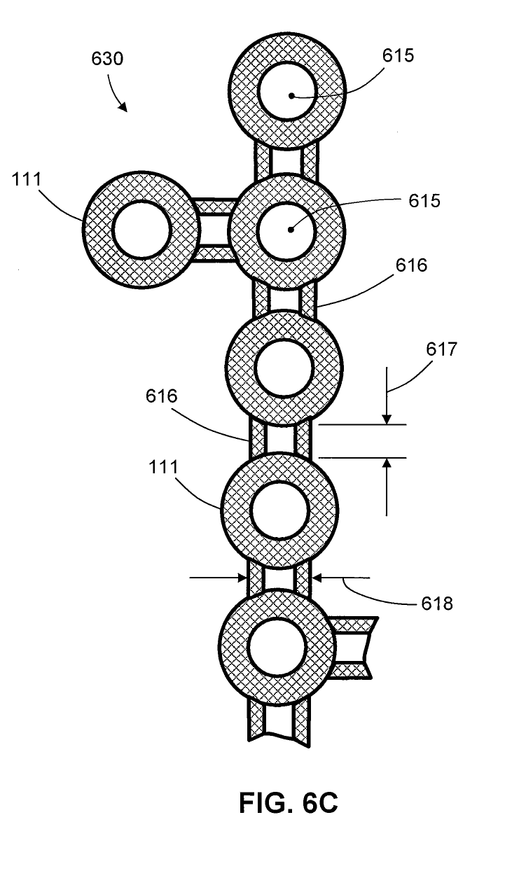

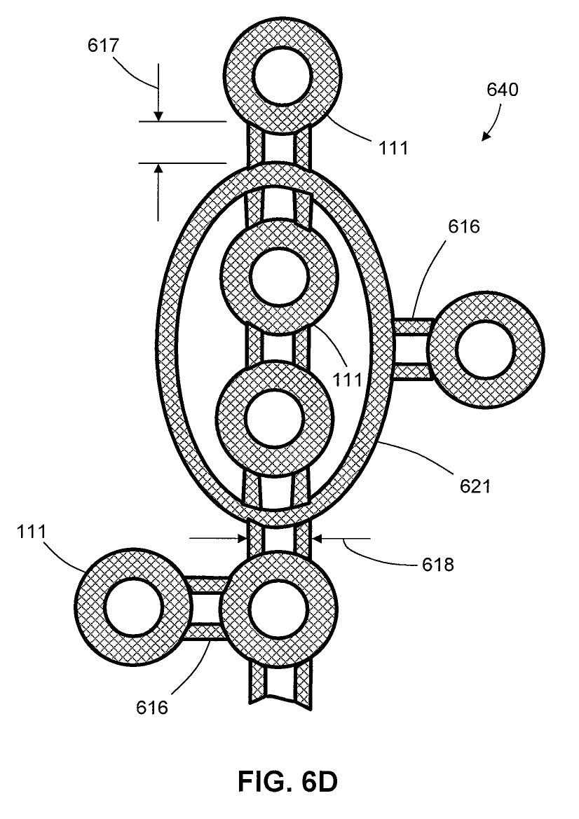

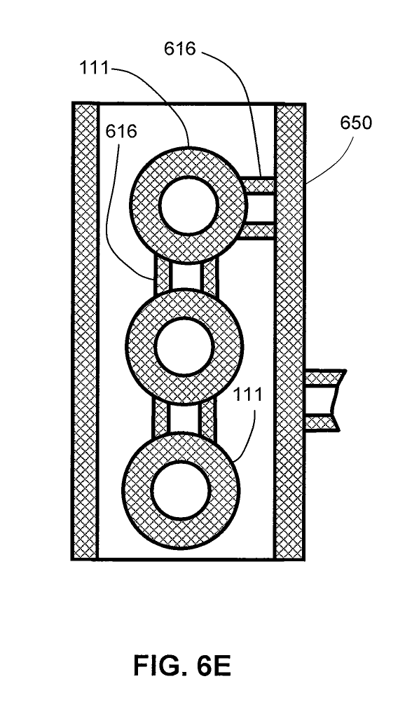

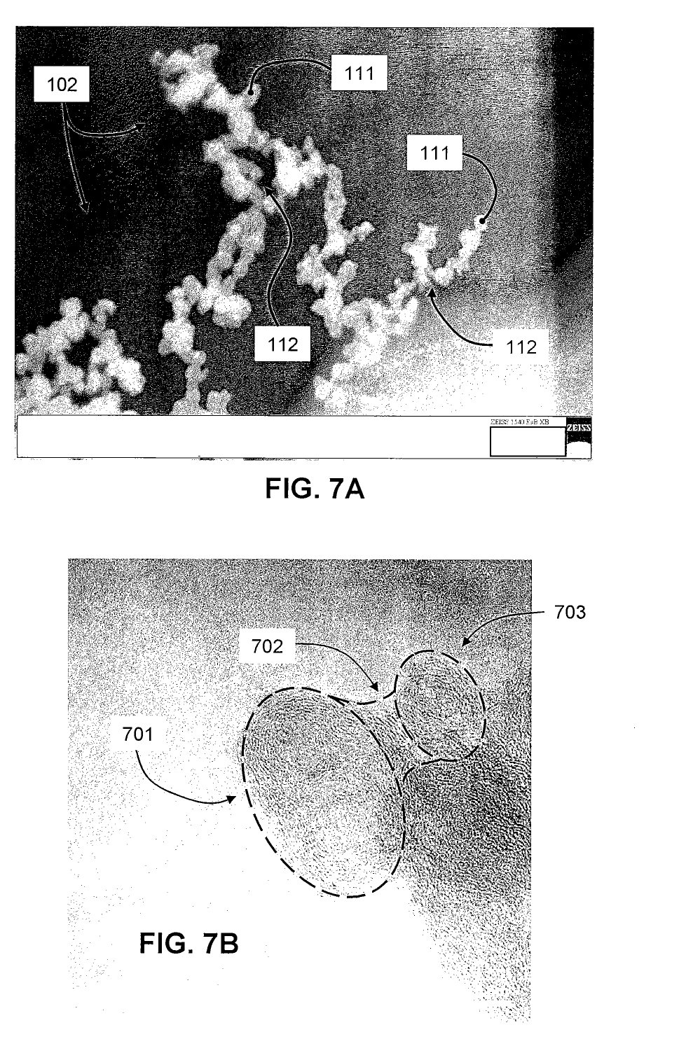

FIGS. 6A-E are schematic illustrations of different configurations of hybrid fullerene chains 610, 620, 630, 640, and 650 that may make up mesoporous carbon material 102, according to embodiments of the invention. FIGS. 6A-E are based on images of mesoporous carbon material 102 obtained by the inventors using scanning electron microscopy (SEM) and transmission electron microscopy (TEM). FIG. 6A schematically depicts a hybrid fullerene chain 610, which is a high-aspect ratio configuration of a plurality of spherical carbon fullerene onions 111 connected by single-walled carbon nanotubes 612. While depicted in FIGS. 6A-E as circular in cross-section, it is known in the art that spherical carbon fullerene onions 111 may not be perfectly spherical. Spherical carbon fullerene onions 111 may also be oblate, oblong, elliptical in cross-section, etc. In addition, the inventors have observed such asymmetrical and/or aspherical shapes of spherical carbon fullerene onions 111 via TEM and SEM, as shown in FIGS. 7A and 7B. Single-walled carbon nanotubes 612 are substantially similar to single-walled carbon nanotubes 112, described above in conjunction with FIG. 4, and are about 1-10 nm in diameter. As shown, single-walled carbon nanotubes 612 form relatively low-aspect ratio connections between spherical carbon fullerene onions 111, where the length 613 of each single-walled carbon nanotube 612 is approximately equal to the diameter 614 thereof. Spherical carbon fullerene onions 111 may each include a C₆₀ molecule or other nano-particle forming the core 615 of each spherical carbon fullerene onion 111 and multiple layers of graphene planes, as described above in conjunction with FIGS. 3A-B.

FIG. 6B schematically depicts a hybrid fullerene chain 620, which is a high-aspect ratio configuration of spherical carbon fullerene onions 111 connected by single-walled carbon nanotubes 612 and also includes single-walled carbon nano-tube shells 619 surrounding one or more of the carbon fullerene onions 111. FIG. 6C schematically depicts a hybrid fullerene chain 630, which is a high-aspect ratio configuration of a plurality of spherical carbon fullerene onions 111 connected by multi-walled carbon nanotubes 616. As shown, multi-walled carbon nanotubes 616 form relatively low-aspect ratio connections between spherical carbon fullerene onions 111, where the length 617 of each multi-walled carbon nanotube 616 is approximately equal to the diameter 618 thereof. FIG. 6D schematically depicts a hybrid fullerene chain 640, which is a high-aspect ratio configuration of spherical carbon fullerene onions 111 connected by multi-walled carbon nanotubes 616 and also includes one or more multi-walled carbon nano-tube shells 621 surrounding one or more of the carbon fullerene onions 111. FIG. 6E depicts a cross-sectional view of a multi-wall carbon nano-tube 650, which may form part of a high-aspect ratio structure contained in mesoporous carbon material 102. As shown, multi-wall carbon nano-tube 650 contains one or more spherical carbon fullerene onions 111 connected to each other and to carbon nano-tube 650 by multi-walled carbon nanotubes 616, where the spherical carbon fullerene onions 111 are contained inside the inner diameter of carbon nano-tube 650.

FIG. 7A is an SEM image of mesoporous carbon material 102 showing carbon fullerene onions 111 formed into high-aspect ratio hybrid fullerene chains, according to embodiments of the invention. In some locations, carbon nanotubes 112 connecting carbon fullerene onions 111 are clearly visible. FIG. 7B is a TEM image of a multi-walled shell 701 connected by a carbon nanotube 702 to another fullerene onion 703, according to an embodiment of the invention.

Methods for forming carbon fullerene onions and carbon nano-tubes are known. However, one of skill in the art will appreciate that hybrid fullerene chains 610, 620, 630, 640, and 650, according to embodiments of the invention, enable the formation of mesoporous carbon material 102 on a conductive substrate. First, such hybrid fullerene chains have extremely high surface area. In addition, due to the nano-scale self-assembly process by which they are formed, the hybrid fullerene chains forming mesoporous carbon material 102 also possess high tensile strength, electrical conductivity, heat resistance, and chemical inactivity. Further, the method of forming such structures is well-suited to the formation of a high-surface-area electrode, since the hybrid fullerene chains forming mesoporous carbon material 102 are mechanically and electrically coupled to a conductive substrate as they are formed, rather than being formed in a separate process and then deposited onto a conductive substrate.

Referring to FIGS. 1A and 1B, the inventors have determined through SEM and TEM imagery that the diameter of the spherical carbon fullerene onions 111 and length of the carbon nanotubes 112 in mesoporous carbon material 102 range between about 5 nm and 50 nm. When mesoporous carbon material 102 is used as an intercalation material in an energy storage device, such at the anode of a Li-ion battery, the internal volumes of spherical carbon fullerene onions 111 and carbon nanotubes 112 serve as sites in which lithium ions may reside. In chemistry, intercalation is the reversible inclusion of a molecule, group, or ion between two other molecules or groups. Thus, the nominal pore size of mesoporous carbon material 102 is between about 5 nm and about 50 nm. The “sponge-like” nature of mesoporous carbon material 102 produces a very high internal surface area therein, thereby allowing mesoporous carbon material 102 to retain a relatively high concentration of lithium ions when filled with an appropriate electrolyte, e.g., a lithium salt in an organic solvent. Energy storage devices that use mesoporous carbon material 102 as an intercalation layer may be smaller and/or have increased energy storage capacity due to the high concentration of lithium ions that can be stored in the intercalation layer.

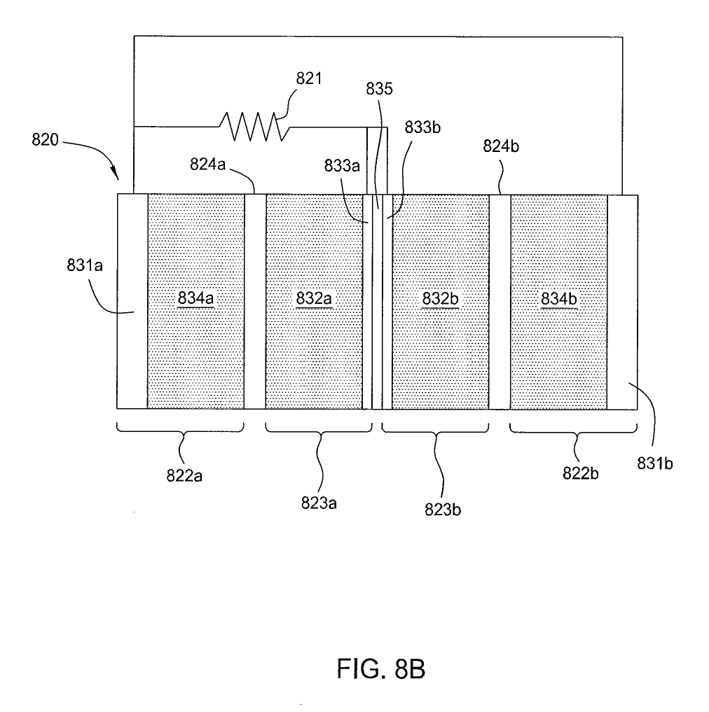

FIG. 8A is a schematic illustration of a Li-ion battery 800 with an intercalation layer 802 formed from a mesoporous carbon material substantially similar to mesoporous carbon material 102, according to an embodiment of the invention. The primary functional components of Li-ion battery 800 include a current collector 801, intercalation layer 802, a cathode structure 803, a separator 804, and an electrolyte (not shown). The electrolyte is contained in intercalation layer 802, cathode structure 803, and separator 804, and a variety of materials may be used as electrolyte, such as a lithium salt in an organic solvent. In operation, Li-ion battery 800 provides electrical energy, i.e., is discharged, when intercalation layer 802 and cathode structure 803 are electrically coupled to load 809, as shown in FIG. 8. Electrons flow from current collector 801 through load 809 to current collector 813 of cathode structure 803, and lithium ions move from the mesoporous carbon material that makes up intercalation layer 802, through separator 804, and into cathode structure 803. Because the mesoporous carbon material that makes up intercalation layer 802 has a high mesoporosity, as detailed above, a high concentration of lithium ions may be stored in intercalation layer 802, thereby reducing the weight and volume of Li-ion battery 800.

FIG. 8B is a schematic diagram of a single sided Li-ion battery cell bi-layer 820 with intercalation layers 834a, 834b electrically connected to a load 821, according to one embodiment described herein. The single sided Li-ion battery cell bi-layer 820 functions similarly to the Li-ion battery 800 depicted in FIG. 8A. The primary functional components of Li-ion battery cell bi-layer 820 include intercalation structures 822a, 822b, cathode structures 823a, 823b, separator layers 824a, 824b, and an electrolyte (not shown) disposed within the region between the current collectors 831a, 831b, 833a, and 833b. The Li-ion battery cell 820 is hermetically sealed with electrolyte in a suitable package with leads for the current collectors 831a, 831b, 833a, and 833b. The intercalation structures 822a, 822b, cathode structures 823a, 823b, and fluid-permeable separator layers 824a, 824b are immersed in the electrolyte in the region formed between the current collectors 831a and 833a and the region formed between the current collectors 831b and 833b. An insulator layer 835 is disposed between current collector 833a and current collector 833b.

Intercalation structures 822a, 822b and cathode structures 823a, 823b each serve as a half-cell of Li-ion battery 820, and together form a complete working bi-layer cell of Li-ion battery 820. Intercalation structures 822a, 822b each include a metal current collector 831a, 831b and an intercalation layer 834a, 834b, such as a carbon-based intercalation host material for retaining lithium ions, having a container layer. Similarly, cathode structures 823a, 823b include a current collector 833a and 833b respectively and a second electrolyte containing material 832a, 832b, such as a metal oxide, for retaining lithium ions. The current collectors 831a, 831b, 833a, and 833b are made of electrically conductive material such as metals. In some cases, a separator layer 824a, 824b, which is an insulating, porous, fluid-permeable layer, for example, a dielectric layer, may be used to prevent direct electrical contact between the components in the intercalation structures 822a, 822b and the cathode structures 823a, 823b. It should also be understood that although a Li-ion battery cell bi-layer 820 is depicted in FIGS. 8A and 8B, the embodiments described herein are not limited to Li-ion battery cell bi-layer structures. It should also be understood, that the intercalation and cathode structures may be connected either in series or in parallel.

Referring to FIG. 1B, the thickness T of mesoporous carbon material 102 is variable depending on the intercalation layer requirements of the energy storage device that contains electrode 100. For example, in Li-ion battery 800 of FIG. 8A, electrode 100 can serve as the current collector 801 and mesoporous carbon material 102 can serve as an intercalation layer 802 for lithium ions at the anode. Consequently, a greater thickness T of mesoporous carbon material 102 results in a greater energy storage capacity for electrode 100. Thickness T of mesoporous carbon material 102 may range from approximately 20 microns to 50 microns, depending on the desired functionality of electrode 100.

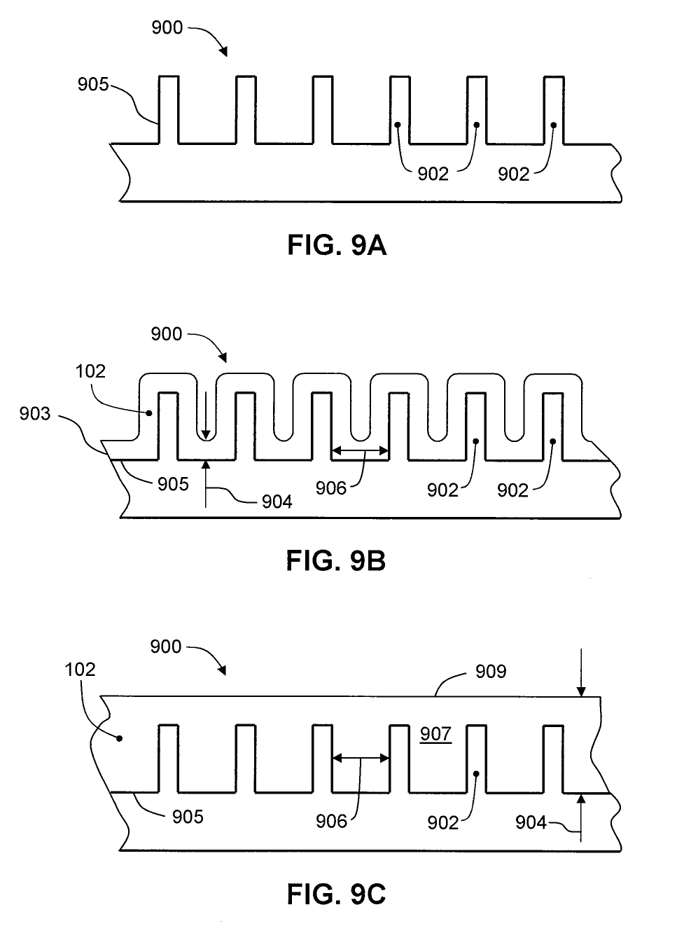

The morphology of surface 105 of conductive substrate 101 may also affect thickness T of mesoporous carbon material 102. In FIG. 1B, surface 105 of substrate 101 is depicted as a uniform plane. However, in some energy storage devices, electrode 100 may be configured to reduce internal resistance of the energy storage device by increasing the surface area of conductive substrate 101. FIG. 9A illustrates a schematic cross-sectional view of a conductive electrode 900 with a surface 905 enhanced with a plurality of high surface area microstructures 902, according to an embodiment of the invention. With the exception of high surface area microstructures 902, electrode 900 is substantially similar to electrode 100 of FIGS. 1A, 1B. High surface area microstructures 902 provide conductive electrode 900 with a significantly higher surface area relative to an electrode having a substantially flat surface. High surface microstructures 902 may be formed on electrode 900 using masking, metal deposition and/or metal etching techniques commonly known in the art, e.g., PVD, electrochemical plating, etc. As illustrated in FIGS. 9B, 9C, it is contemplated that the thickness of mesoporous carbon material 102 may vary when formed on electrode 900, depending on the morphology of microstructures 902 and on the intended use of electrode 900.

FIG. 9B illustrates electrode 900 with mesoporous carbon material 102 formed as a thin layer 903 deposited conformally on high surface area microstructures 902, according to an embodiment of the invention. The process by which mesoporous carbon material 102 is formed on a substrate is a conformal process, and is described below in conjunction with FIG. 8. In such an embodiment, the thickness 904 of mesoporous carbon material 102 is substantially less than the separation 906 between each of the high surface area microstructures 902, as shown. In this way, the surface area of electrode 900 is not significantly reduced after the formation of mesoporous carbon material 102, which may be beneficial for some applications of electrode 900 in energy storage devices. FIG. 9C illustrates electrode 900 with mesoporous carbon material 102 formed thereon as a planarizing layer 907, according to an embodiment of the invention. In such an embodiment, mesoporous carbon material 102 is formed on electrode 900 to have a thickness 904 that fills the separation 906 between each of high surface area microstructures 902 and forms a substantially planarized surface 909 on electrode 900, as shown. The relatively large volume of mesoporous carbon material 102 that is formed on electrode 900 and planarized surface 909 are known to be beneficial for some applications of electrode 900 in energy storage devices.

Because spherical carbon fullerene onions 111 and carbon nanotubes 112 in mesoporous carbon material 102 are formed and interconnected by a nano-scale self-assembly process, a layer of mesoporous carbon material 102 formed on the surface of an electrode will have a higher electrical conductivity than other carbon-based intercalation materials known in the art, such as materials formed from graphene flakes. In one embodiment, a 50-micron thick layer of mesoporous carbon material 102 deposited as high conductivity chains on a conductive substrate. Such improved conductivity beneficially reduces internal resistance and shortens charging/discharging times of energy storage devices using mesoporous carbon material 102 as an intercalation layer. In one embodiment, the density of mesoporous carbon material 102 may be between 30% and 50% of the density of prior art intercalation materials. In another embodiment, the density of mesoporous carbon material 102 may be between 50% and 80% of the density of prior art intercalation materials.

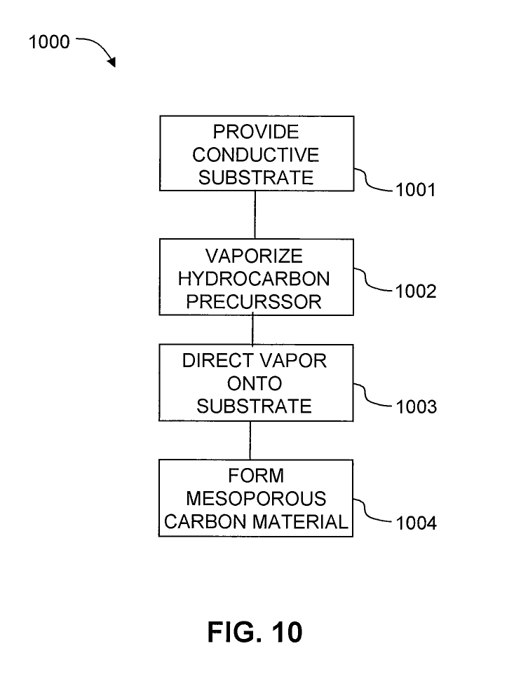

FIG. 10 is a process flow chart summarizing a method 1000 for forming mesoporous carbon material 102 on electrode 100 of FIG. 1A, according to one embodiment of the invention. In step 1001, conductive layer 121 is formed on a surface of non-conductive substrate 120. Conductive layer 121 may be formed using one or more metal thin-film deposition techniques known in the art, including electrochemical plating, electroless plating, PVD, CVD, ALD, and thermal evaporation, among others. Alternatively, a conductive substrate is provided in step 1001, such as a metallic foil or metallic plate.

In steps 1002-1004, mesoporous carbon material 102 is formed on the conductive substrate. Unlike prior art methods for forming Fullerenes, no catalytic nano-particles, such as iron (Fe) or nano-diamond particles, are used in step 1002 to form mesoporous carbon material 102. Instead, mesoporous carbon material 102 is formed on a surface 105 of conductive substrate 101 using a CVD-like process that allows the carbon atoms in a hydrocarbon precursor gas to undergo a continuous nano-scale self-assembly process on surface 105.

In step 1002, a high molecular weight hydrocarbon precursor, which may be a liquid or solid precursor, is vaporized to form a precursor gas. A hydrocarbon precursor having 18 or more carbon atoms may be used, such as hydrocarbon precursors selected from the group comprising, consisting of, or consisting essentially of: C₂₀H₄₀, C₂₀H₄₂, C₂₂H₄₄, etc. The precursor is heated to between 300° C. and 1400° C., depending on the properties of the particular hydrocarbon precursor used. One of skill in the art can readily determine the appropriate temperature at which the hydrocarbon precursor should be heated to form a vapor for such a process.

In step 1003, the hydrocarbon precursor vapor is directed onto the surface of the conductive substrate, where the temperature of the conductive substrate is maintained at a relatively cold temperature, e.g., no greater than about 220° C. The temperature at which the conductive surface is maintained during this process step may vary as a function of substrate type. For example, in one embodiment, the substrate includes a non-temperature resistant polymer, and may be maintained at a temperature between about 100° C. and 300° C. during step 1003. In another embodiment, the substrate is a copper substrate, such as a copper foil, and may be maintained at a temperature between about 300° C. and 900° C. during step 1003. In yet another embodiment, the substrate consists of a more heat-resistant material, such as stainless steel, and is maintained at a temperature of up to about 1000° C. during step 1003. The substrate may be actively cooled during the deposition process with backside gas and/or a mechanically cooled substrate support. Alternatively, the thermal inertia of the substrate may be adequate to maintain the conductive surface of the substrate at an appropriate temperature during the deposition process. A carrier gas, such as argon (Ar) or nitrogen (N₂), may be used to better deliver the hydrocarbon precursor gas to the surface of the conductive substrate. For improved uniformity of gas flow, the mixture of hydrocarbon precursor vapor and carrier gas may be directed to the conductive surface of the substrate through a showerhead. Both low-vacuum, i.e., near atmospheric, and high-vacuum CVD processes may be used to form mesoporous carbon material 102. For improved uniformity of gas flow, the mixture of hydrocarbon precursor vapor and carrier gas may be directed to the conductive surface of the substrate through a showerhead. Alternatively, the hydrocarbon precursor vapor and/or a carrier gas may be introduced into a process chamber via one or more gas injection jets, where each jet may be configured to introduce a combination of gases, or a single gas, e.g., carrier gas, hydrocarbon precursor vapor, etc. Atmospheric and near-atmospheric CVD processes allow deposition onto larger surface area substrates, higher throughput, and lower-cost processing equipment. Higher-vacuum processes allow the formation of mesoporous carbon material 102, and conductive layer 121 in-situ, i.e., using consecutive deposition processes without exposure of the substrate to atmosphere. Higher-vacuum processes also provide lower potential contamination of deposited layers and, thus, better adhesion between deposited layers.

In step 1004, the fullerene-hybrid material is formed on the surface of the conductive substrate. Under the conditions so described, the inventors have determined that carbon nano-particles contained in the hydrocarbon precursor vapor will “self-assemble” on the cool surface into mesoporous carbon material 102, i.e., a matrix of three-dimensional structures made up of fullerene onions connected by nanotubes. Thus, the process is a catalytic nano-particle-free process where no catalytic nano-particles are used to form mesoporous carbon material 102. In addition, the fullerene-containing material that forms mesoporous carbon material 102 does not consist of individual nano-particles and molecules. Rather, mesoporous carbon material 102 is made up of high aspect ratio, dendritic structures that are mechanically bonded to the surface of the conductive substrate. Thus, a subsequent anneal process is not required to bond spherical carbon fullerene onions 111 and carbon nanotubes 112 with each other or with the conductive substrate.

Experimental observations at different times during the self-assembly process by SEM show that self-assembly begins with the formation of scattered individual nano-carbon chains having high aspect ratios. The fullerene onion diameters are in the range of 5-20 nm and the hybrid fullerene chains are up to 20 microns in length. It is believed that the growth of such fullerene chains is initiated on copper grain boundaries and/or defects in the copper lattice. As the self-assembly progresses, the hybrid fullerene chains become interconnected with each other to form a layer of highly porous material, i.e., fullerene-hybrid material 102 in FIG. 1. The self-assembly process of interconnected hybrid fullerene chains continues as a self-catalytic process. Layers of 1, 10, 20, 30, 40, and 50 microns thick nano-Carbon material have been observed.

It is noted that the process described in step 1002 is substantially different from processes known in the art for depositing carbon nanotube-containing structures on a substrate. Such processes generally require the formation of carbon nanotubes or graphene flakes in one process step, the formation of a slurry containing the pre-formed carbon nanotubes or graphene flakes and a binding agent in a second process step, the application of the slurry to a substrate surface in a third process step, and the anneal of the slurry in a final process step to form an interconnected matrix of carbon molecules on the substrate. The method described herein is significantly less complex, can be completed in a single processing chamber, and relies on a continuous self-assembly process to form high aspect ratio carbon structures on a substrate rather than on an anneal step. The self-assembly process is believed to form carbon structures of greater chemical stability and higher electrical conductivity than slurry-based carbon structures, both of which are beneficial properties for components of energy storage devices. Further, the lack of a high temperature anneal process allows for the use of a wide variety of substrates on which to form the carbon structures, including very thin metal foils and polymeric films, among others.

In one process example, a fullerene-hybrid material substantially similar to mesoporous carbon material 102 is formed on a conductive layer formed on the surface of a non-conductive substrate, where the non-conductive substrate is a heat resistance polymer and the conductive layer is a copper thin-film formed thereon. A precursor containing a high molecular weight hydrocarbon is heated to 300-1400° C. to produce a hydrocarbon precursor vapor. Argon (Ar), nitrogen (N₂), air, carbon monoxide (CO), methane (CH₄), hydrogen (H₂), and combinations thereof at a maximum temperature of 700-1400° C. is used as a carrier gas to deliver the hydrocarbon precursor vapor to a CVD chamber having a process volume of approximately 10-50 liters. The flow rate of the hydrocarbon precursor vapor is approximately 0.2 to 5 sccm, the flow rate of the carrier gas is approximately 0.2 to 5 sccm, and the process pressure maintained in the CVD chamber is approximately 10⁻² to 10⁻⁴ Torr. The substrate temperature is maintained at approximately 100° C. to 700° C., and the deposition time is between about 1 second and 60 seconds, depending on the thickness of deposited material desired. In one embodiment, oxygen (O₂) or air is also introduced into the process volume of the CVD chamber at a flow rate of 0.2-1.0 sccm at a temperature of between about 10° C. and 100° C. to produce a combustion-like CVD process. A reaction takes place at about 400° C. and 700° C. in a reaction region between the substrate surface and the gas injection jets or showerhead. The above process conditions yield a fullerene-hybrid material substantially similar to fullerene-hybrid material 102, as described herein.

In certain embodiments, the mesoporous carbon material described herein may be part of a composite anode structure. In certain embodiments, the composite anode structure comprises, consists of, or consists essentially of the mesoporous carbon material and material selected from the group comprising tin, silicon, oxygen, and combinations thereof. Examples of composite anode structures include mesoporous carbon-tin-silicon, mesoporous carbon-silicon-oxygen, mesoporous carbon-tin, and mesoporous carbon silicon.

In certain embodiments, the mesoporous carbon material described herein may be part of a composite cathode structure. In certain embodiments, the composite cathode structure comprises, consists of, or consists essentially of the mesoporous carbon material and material selected from the group comprising manganese oxides, nickel-manganese-cobalt (NMC), BiF₃, iron, and combinations thereof. Examples of composite cathode structures include mesoporous carbon-nickel-manganese-cobalt, mesoporous carbon-Bi F₃, mesoporous carbon-iron, and mesoporous carbon-manganese-oxide.

In one embodiment, lithium is inserted into the composite electrode structure after first charge. In another embodiment, lithium is inserted into the composite anode structure via a pre-lithiation process by exposing the composite anode structure to a lithium containing solution. In one embodiment, the pre-lithiation process may be performed by adding a lithium source to the aforementioned plating solutions. Suitable lithium sources include but are not limited to LiH₂PO₄, LiOH, LiNO₃, LiCH₃COO, LiCl, Li₂SO₄, Li₃PO₄, Li(C₅H₈O₂), lithium surface stabilized particles (e.g. carbon coated lithium particles), and combinations thereof. The pre-lithiation process may further comprise adding a complexing agent, for example, citric acid and salts thereof to the plating solution.

In certain embodiments, the pre-lithiation process may be performed by applying lithium to the electrode in a particle form using powder application techniques including but not limited to sifting techniques, electrostatic spraying techniques, thermal or flame spraying techniques, fluidized bed coating techniques, slit coating techniques, roll coating techniques, and combinations thereof, all of which are known to those skilled in the art.

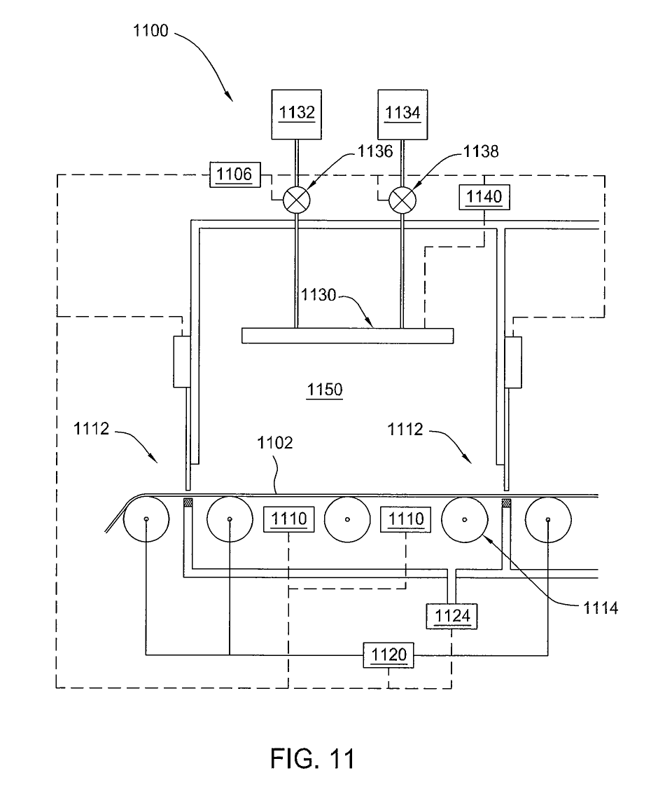

FIG. 11 is a schematic side view of one embodiment of a chemical vapor deposition (CVD) processing chamber 1100 for performing embodiments described herein. In one embodiment, the processing chamber 1100 is used to form a mesoporous intercalation layer over the substrate 1102 positioned in a processing region 1150 using a chemical vapor deposition (CVD) process. In chamber 1100, process gasses are provided to a showerhead 1130 from one or more gas sources 1132, 1134 via valves 1136, 1138, respectively. Valves 1136, 1138 are controlled by signals received from the support circuits of a system controller 1106. The process gasses provided to the showerhead 1130 include gasses used to form the carbon mesoporous intercalation layer. While in this embodiment, two gas sources 1132, 1134 are shown, a single gas source or a plurality of gas sources may be provided depending on the number and combination of gases used. In one embodiment, to improve the film quality, increase the deposition rate and/or film uniformity, the CVD process may be enhanced by applying a bias to the showerhead 1130 and/or the substrate 1102. In one embodiment, a power supply 1140 is configured to RF bias the showerhead 1130 based on signals received from the support circuits of the system controller 1106. The applied voltage may be RF, DC or AC depending on system requirements. In another embodiment, an inductively coupled plasma may also be formed in the processing region 1150 by use of the power supply 1140.

A series of substrate transfer ports 1112 are provided at the entrance and exit of the processing chamber 1100 to allow the substrates to pass between chambers, while maintaining the required environment within each chamber during processing. A series of rollers 1114 supports the substrate 1102 as it is guided through the various chambers. In some embodiments, a drive belt (not shown) may be included to form a conveyor to provide additional support to the web 1102 between the rollers 1114. The rollers 1114 may be mechanically driven by a common drive system (not shown) such that they are controlled in unison, thereby avoiding wrinkling or stretching of the web 1102. The rollers 1114 may advance the web 1102 into the subsequent chambers, based on commands received by a drive mechanism 1120 from a system controller (not shown). In one embodiment, a pumping device 1124 is coupled to the processing region 1150 to evacuate and control the pressure therein. In embodiments requiring cooling or heating of the substrate 1102, one or more temperature regulation elements 1110 may be provided.

While the foregoing is directed to embodiments of the present invention, other and further embodiments of the invention may be devised without departing from the basic scope thereof, and the scope thereof is determined by the claims that follow.

We claim:

1. A method of forming a mesoporous intercalation layer on an electrode, comprising:
vaporizing a high molecular weight hydrocarbon precursor; and
directing the vaporized high molecular weight hydrocarbon precursor onto a conductive substrate to deposit a mesoporous carbon material comprising carbon fullerene onions and carbon nano-tubes thereon,
wherein the high molecular weight hydrocarbon precursor comprises molecules having at least 18 carbon (C) atoms and wherein a diameter of the spherical carbon fullerene onions and a length of the carbon nanotubes are between about 5 nm and about 50 nm.

2. The method of claim 1, wherein the high molecular weight hydrocarbon precursor is selected from the group comprising C₂₀H₄₀, C₂₀H₄₂, C₂₂H₄₄, and combinations thereof.

3. The method of claim 1, further comprising maintaining a surface of the conductive substrate at a cold temperature while directing the vaporized high molecular weight hydrocarbon precursor onto a conductive substrate, wherein maintaining the substrate at a cold temperature comprises at least one of actively cooling the conductive substrate with a backside gas and mechanically cooling a substrate support on which the conductive substrate is positioned.

4. The method of claim 1, wherein the mesoporous carbon material is made up of high aspect ratio, dendritic structures that are mechanically bonded to a surface of the conductive substrate.

5. The method of claim 3, wherein carbon nano-particles within the vaporized high molecular weight hydrocarbon precursor self-assemble on the cooled surface of the conductive substrate to form the mesoporous carbon material via a self-assembly process.

6. The method of claim 5, wherein the self-assembly process comprises:
forming scattered individual nano-carbon hybrid fullerene chains having high aspect ratios; and
interconnecting the individual nano-carbon hybrid fullerene chains to form the mesoporous carbon material.

7. The method of claim 1, wherein vaporizing a high molecular weight hydrocarbon precursor comprises heating the high molecular weight precursor to a temperature between 300 degrees Celsius and 1,400 degrees Celsius.

8. The method of claim 7, wherein directing the vaporized high molecular weight hydrocarbon precursor onto a conductive substrate comprises flowing a carrier gas selected from the group comprising argon (Ar), nitrogen (N₂), air, carbon monoxide (CO), methane (CH₄), hydrogen (H₂), and combinations thereof at a maximum temperature of between 700 degrees Celsius and 1400 degrees Celsius to deliver the hydrocarbon precursor vapor to a CVD chamber having a process volume of approximately 10-50 liters.

9. The method of claim 8, wherein a flow rate of the hydrocarbon precursor vapor is between 0.2 sccm to 5 sccm, a flow rate of the carrier gas is between 0.2 sccm to 5 sccm, and a pressure within the CVD chamber is maintained between 10⁻² Torr and 10⁻⁴ Torr.

10. The method of claim 9, further comprising flowing oxygen (O₂) into the process volume of the CVD chamber with the hydrocarbon precursor vapor at a flow rate between 0.2 to 1.0 sccm at a temperature of between 10° C. and 100° C. to produce a combustion-like CVD process.

11. An electrode for an energy storage device, comprising:
a conductive substrate; and
a mesoporous carbon material comprising carbon fullerene onions and carbon nano-tubes formed on a surface of the conductive substrate, wherein a diameter of the spherical carbon fullerene onions and a length of the carbon nanotubes are between about 5 nm and about 50 nm.

12. The electrode of claim 11, wherein the surface of the conductive substrate comprises high-surface-area microstructures.

13. The electrode of claim 12, wherein the mesoporous carbon material forms a conformal layer on the high-surface-area microstructures.

14. The electrode of claim 11, wherein the mesoporous carbon material forms a planarizing layer on the high-surface-area microstructures.

15. The electrode of claim 11, wherein the mesoporous carbon material comprises three or more fullerene onions connected by a carbon nano-tube.

16. The electrode of claim 11, wherein the mesoporous carbon material comprises high-aspect-ratio chains of fullerene onions, wherein the high-aspect-ratio chains are at least about 1 micron in length.

17. The electrode of claim 11, wherein the mesoporous carbon material is part of a composite structure selected from the group comprising: mesoporous carbon-tin-silicon, mesoporous carbon-silicon-oxygen, mesoporous carbon-tin, and mesoporous carbon silicon

18. A mesoporous intercalation layer, comprising:
a first carbon fullerene onion having a first diameter of between about 5 nm and about 50 nm;
a first carbon nano-tube connected to the first carbon fullerene onion and having a first length of between about 5 nm and about 50 nm;
a second carbon fullerene onion connected to the carbon nano-tube and having a second diameter of between about 5 nm and about 50 nm;
a second carbon nano-tube connected to the first carbon nano-tube and having a second length of between about 5 nm and about 50 nm; and
a third carbon fullerene onion connected to the second carbon nano-tube and having a third diameter of between about 5 nm and about 50 nm.

19. The mesoporous intercalation layer of claim 18, wherein the first carbon nano-tube is a multi-walled carbon nano-tube.

20. The mesoporous intercalation layer of claim 18, wherein the first carbon fullerene onion is a multi-walled carbon fullerene onion.

21. The mesoporous intercalation layer of claim 18, wherein the first and second carbon nano-tubes and the first, second, and third carbon fullerene onions form a portion of a high-aspect-ratio chain, wherein the high-aspect-ratio chain is at least about 1 micron in length.
